(19) United States
(12) Patent Application Publication
(10) Pub. No.: US 2004/0177763 A1
(43) Pub. Date: Sep. 16, 2004

(54) Sound insulating appliance for coffee grinders

(76) Inventor: Gregory L. Robillard III, Deephaven, MN (US)

Correspondence Address: Walter C. Linder, FAEGRE & BENSON LLP, 2200 Wells Fargo Center, 90 South Seventh Street, Minneapolis, MN, 55402-3901, US

(21) Appl. No.: 10/385,861

(22) Filed: Mar. 11, 2003

(51) Int. Cl. A23F 3/00

(52) U.S. Cl. 99/286

(57) ABSTRACT

The present invention is directed to a sound insulating appliance for reducing the sound created by coffee grinders. The appliance can be integral to the coffee grinder, insulating the grinder and preventing transfer of vibration on a supporting surface. Alternatively, the invention can surround the coffee grinder, providing an opening for the electrical cord and allowing the operator to actuate the coffee grinder from outside the appliance. The appliance utilizes polyurethane foam as an insulation medium.

### FIELD OF THE INVENTION

The present invention generally relates to coffee bean grinders. In particular, the present invention is a device for reducing the sound created by an operating coffee grinder.

### BACKGROUND OF THE INVENTION

While many consumers purchase pre-ground coffee, a significant number buy whole bean coffees and grind their beans at home. Grinding coffee beans immediately before use typically provides fresher, more Favorable coffee. A wide variety of coffee beans are available allowing consumers to enjoy and combine different flavors of coffee. Thus, electric coffee grinders have become common household appliances.

Unfortunately, these devices grind coffee very loudly. Coffee is often brewed early in the morning, so using a coffee grinder may inadvertently awaken other members of a household. At any time of day, a person grinding coffee as well as anyone in the vicinity is subjected to an unpleasant sound, which can interrupt conversations or otherwise disturb or annoy.

### SUMMARY OF THE INVENTION

The present invention is directed to an appliance that interfaces with a coffee grinder to reduce the sound created by an operating grinder. The invention can, for example, be used with a coffee grinder of the type that is cylindrically shaped, and having a blade-type grinding mechanism in a grinding compartment covered by a removable cover. When the cover is removed, coffee can be added to or removed from the grinding compartment. The cover often includes a mechanism to engage an electrical switch located within the grinder. Thus, when the cover is properly placed upon the grinder, and the mechanism is actuated, the blade will rotate and grind coffee in the grinding compartment.

In one embodiment of the invention, a coffee grinder is placed within the appliance to substantially enclose the coffee grinder. This appliance includes a housing and a removable lid. The housing may include a bottom member, preferably made of a rubber-like material, upon which the coffee grinder is seated, and a cylindrically-shaped hollow shell. The shell is placed over the main body of the coffee grinder and is attached to the bottom member. The lid is shaped so that it fits over the top of the coffee grinder and rests on the top of the shell to enclose the grinder. In addition, the appliance can include structure to actuate the coffee grinder and to allow any power cord to extend through it.

An alternative embodiment of the invention includes insulation material integral to the coffee grinder. The grinder may also have an isolation mechanism attached to the bottom of the grinder to minimize the transfer of vibration from the grinder to the surface upon which it rests. The present invention can also be adapted to provide sound insulation for other styles of coffee grinders including those that use millstones to grind coffee.

### BRIEF DESCRIPTION OF THE DRAWINGS

FIG. 1 is an isometric view of a prior art cylindrical blade type coffee grinder.

FIG. 2 is a side view of the sound-reducing appliance according to one embodiment of the invention, with a cylindrically shaped coffee grinder located within the appliance.

FIG. 3 is an isometric view of the base of the appliance shown in FIG. 2.

FIG. 4 is side view of a second embodiment of the invention.

FIG. 5 is a top, cross-sectional view of a third embodiment of the invention, a cylindrical, blade-type coffee grinder with integral sound reducing material.

FIG. 6 is a front view of a fourth embodiment of the invention, a cylindrical, blade-type coffee grinder with sound reducing material attached to the exterior surface of the grinder.

FIG. 7 is a front view of the fourth embodiment of the invention with a lid that is attached to the sound reducing material on the exterior surface of the grinder.

FIG. 8 is a front view of another alternative of the fourth embodiment.

### DETAILED DESCRIPTION OF THE PREFERRED EMBODIMENTS

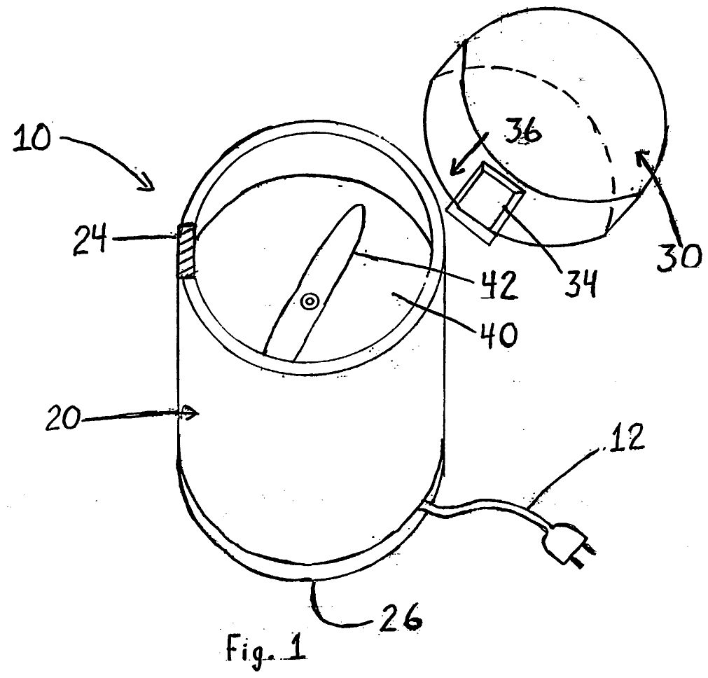

Referring to FIG. 1, a typical prior art coffee grinder 10 is comprised of main body 20, and cover 30. Mounted inside main body 20 is an electric motor (not shown) coupled to power cord 12, which can connect grinder 10 to a standard household electrical outlet. Mounted in main body 20 is a switch (not shown) that is electrically in series with the motor and is actuated to control the application of power to the motor. Aperture 24 is an opening on main body 20 that provides access to the switch. Main body 20 further includes compartment 40, a cavity that holds coffee beans. Compartment 40 typically includes a grinding mechanism 42, which in the illustrated embodiment is a rotating blade, coupled to the motor.

Cover 30 is typically made of plastic or other suitable material and is designed to enclose compartment 40. Cover 30 typically includes an actuation member 34, which in the illustrated embodiment is a moveable member designed to actuate the switch. When cover 30 is properly placed upon main body 20, actuation mechanism 34 is aligned with aperture 24. Application of a force in the direction of arrow 36 will cause actuation mechanism 34 to move through aperture 24, actuate the switch, and allow power to be applied to the motor causing grinding mechanism 42 to grind coffee beans.

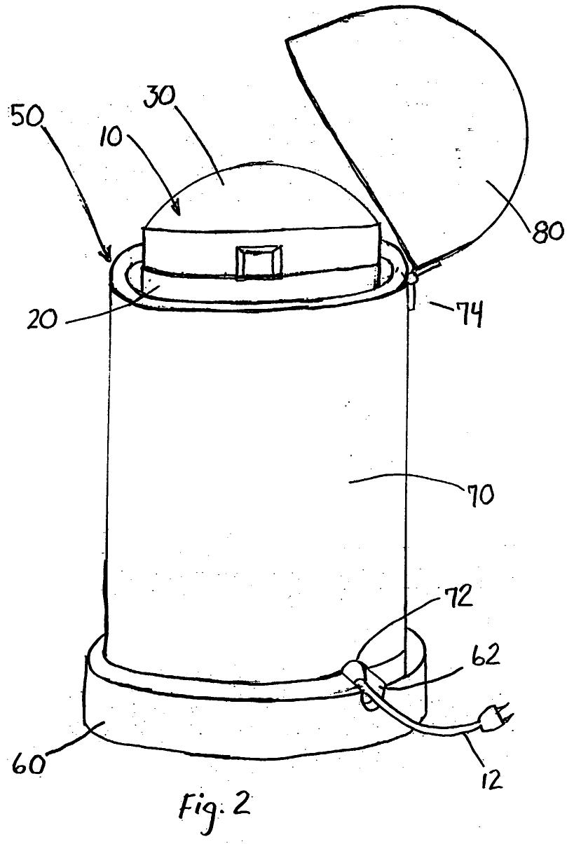

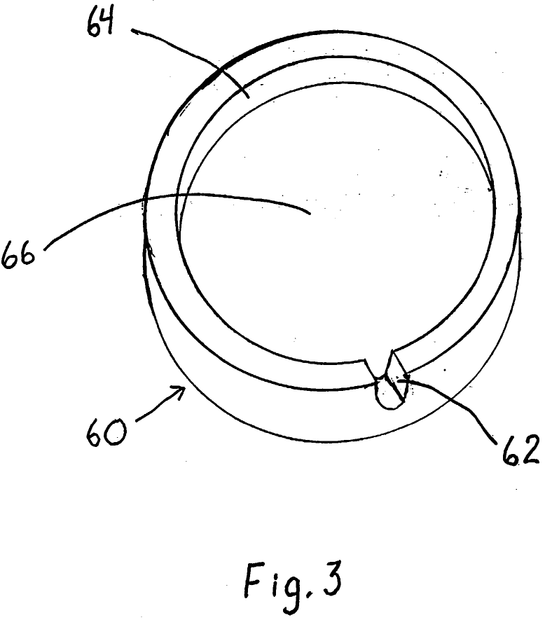

FIG. 2 illustrates grinder 10 located within sound insulation appliance 50 in accordance with a first embodiment of the invention. Appliance 50 includes base 60, shell 70, and lid 80, which combine to substantially enclose grinder 10. Base 60 is comprised of a soft durometer rubber, polymer, or other suitable vibration isolation material, and is designed to allow grinder 10 to rest upon it. Referring to FIG. 3, base 60 includes support area 66 that is large enough to accept bottom surface 26 of grinder 10. The top surface of base 60 has a lip 64 that extends above support area 66 around the circumference of base 60. Lip 64 preferably includes notch 62, which is designed to accept power cord 12.

Shell 70 is preferably hollow and cylindrically-shaped and constructed of a suitable sound insulation material, such as closed cell polyurethane foam. Shell 70 may have an additional outer layer made of aluminum or other suitably hard material. Shell 70 is preferably designed to fit over main body 20 and attach to base 60 to substantially enclose a majority of main body 20 of grinder 10. Shell 70 preferably includes notch 72 that is aligned with notch 62 when base 60 and sleeve 70 are attached so that power cord 12 of grinder 10 can feed through the resultant opening. In other embodiments (not shown), a power cord may feed through a hole in shell 70. Further, a plug (not shown) made of insulating material may be included to fill part of the hole after the power cord has been fed through it. Other structures and approaches can also be used to couple the grinder power cord through the appliance. Alternatively, no cord accommodating structure is required if the coffee grinder has batteries or another self-contained power source.

Shell 70 may fit snugly within or over lip 64, such that the friction between shell 70 and lip 64 provides the only attachment mechanism between shell 70 and base 60. Alternatively, the attachment mechanism between sleeve 70 and base 60 may take many other forms, including any suitable structure to adhere or otherwise attach sleeve 70 to base 60. It is to be understood that in alternative embodiments, base 60 may not include structure such as lip 64. Alternatively, shell 70 and base 60 may be integrated into a single component or the appliance may include shell 70 and not base 60.

Lid 80 is preferably made of sound insulating material identical or similar to that used in shell 70. Alternatively, lid 80 may have an outer layer (not shown) constructed of a hard material covering at least some sound insulating material. The outer layer may be made of the same or similar material as the outer layer of shell 70 described above. Lid 80 fits over cover 30 and preferably rests on the top edge of shell 70. In one embodiment, lid 80 is attached to shell 70 by a hinge 74. Alternatively, lid 80 may be shaped so that it fits over the top of and is completely removable from shell 70.

When lid 80 is properly placed upon shell 70, the operator can grind coffee beans by pressing upon lid 80 so that the insulation material of lid 80 deforms to apply sufficient pressure against actuation mechanism 34 so as to actuate the switch. When the coffee beans are sufficiently ground, the operator can remove the ground coffee by moving lid 80 to an open position as depicted in FIG. 2, removing cover 30, and pouring the coffee out of compartment 40. It is preferable that the height of shell 70 is lower than main body 20 when grinder 10 is seated in the appliance to minimize the potential of spilling coffee inside the appliance when pouring coffee out of compartment 40.

Alternatively, appliance 50 may include other structure to enable the actuation of actuation mechanism 34. For example, lid 80 may include a mechanism such as a hard plastic device that, when depressed, interfaces with actuation mechanism 34 causing the grinder to operate. It is to be further understood that the present invention may be adapted to coffee grinders that have alternative switch actuation mechanisms including rotational switches, pressure sensitive switch mechanisms and the like located anywhere on grinder 10, for example, on the main body. Alternative embodiments may include access to directly actuate or may provide structure to indirectly actuate such switch mechanisms.

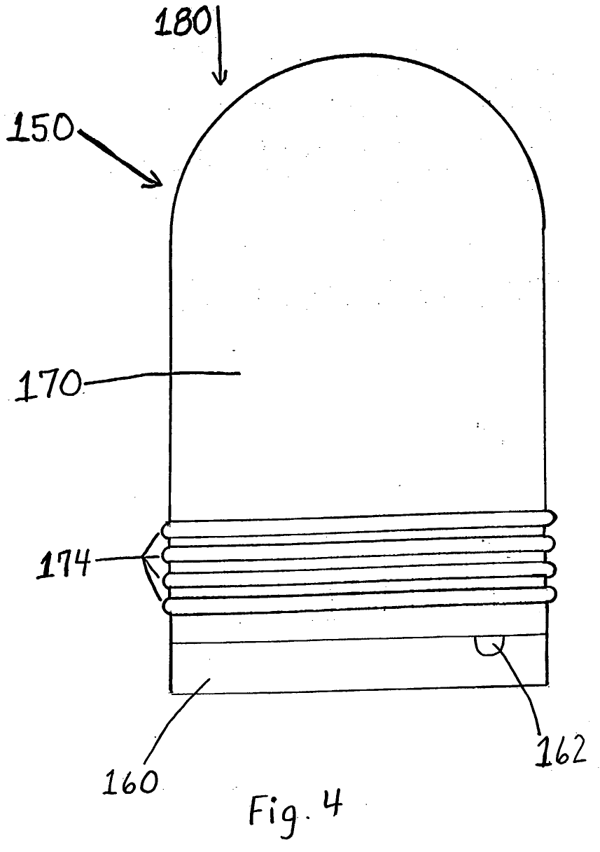

While a first embodiment of the invention is described above, it may be configured in other embodiments. For example, FIG. 4 shows a second embodiment, a sound insulation appliance 150 that includes base 160 and housing 170. Base 160 and housing 170 may be constructed of similar or identical materials as base 60 and shell 70, respectively. Grinder 10 (not shown in FIG. 4) rests on base 160 and power cord 12 extends through notch 162.

Housing 170 includes bellows 174, a series of corrugations shaped into housing 170. When an operator applies force in the direction of arrow 180, bellows 174 will compress, allowing housing 170 to adapt to the different sizes of coffee grinders. By applying pressure in the direction of arrow 180, housing 170 is deformed so as to engage switch actuation mechanism 34 and actuate grinder 10 as described in earlier embodiments. Housing 170 may be attached to base 160 by any desired structure or method, including those described in earlier embodiments.

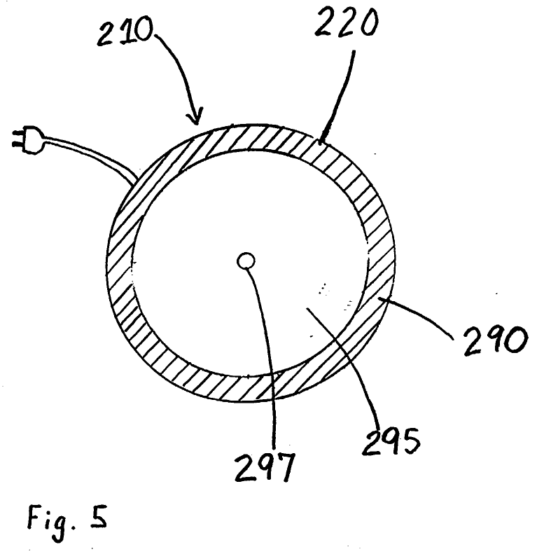

In a third embodiment, insulation material is integrated within the main body of a coffee grinder. The insulation material may be identical or similar to that described in earlier embodiments. Referring to FIG. 5, a cross-sectional view of coffee grinder 210 is shown. The cross-section shows the top of an electric motor 295 with output shaft 297 located within the outer wall of main body 220. Sound insulation material 290 is shown between motor 295 and the outer wall of main body 220. It is to be understood that sound insulation material such as 290 may be placed below and above motor 295 and in any volume not otherwise occupied within the confines of main body 220. It is to be further understood that a cover (not shown) may also include or be formed from sound insulation material. Further, isolation material, such as rubber-like materials, foams, or other materials having sound and/or vibration absorbing characteristics, may be used to inhibit the transfer of vibration to any surface upon which grinder 210 rests. While sound insulation material 290 is shown to fill otherwise unoccupied volume within main body 220, it is to be understood that sound insulation material 290 need not fill the entire unoccupied volume.

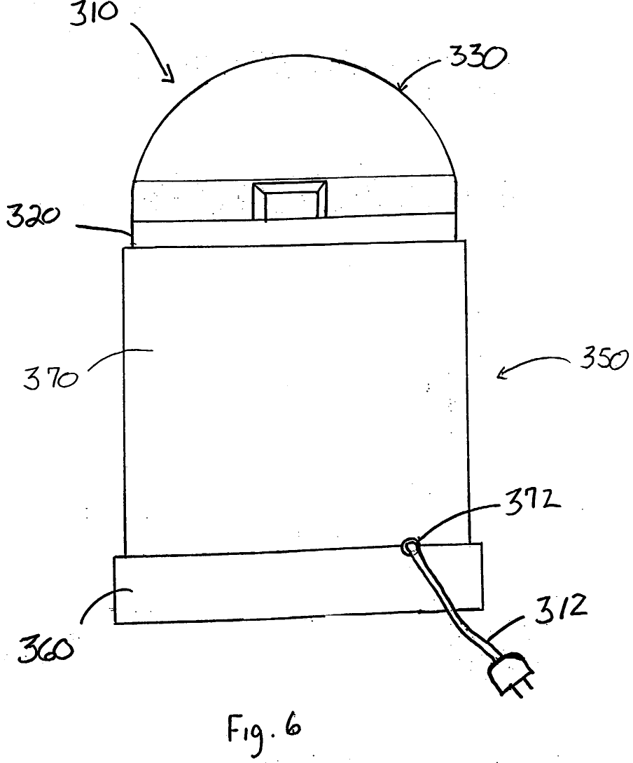

In a fourth embodiment, shown in FIG. 6, a sound insulation appliance 350 includes insulation material attached permanently to the exterior surface of coffee grinder 310. The insulation material may be identical or similar to that described in earlier embodiments. Sound insulation appliance 350 includes shell 370 which surrounds and is attached to a significant portion of main body 320 of coffee grinder 310. Shell 370 is made of similar insulation materials as described in earlier embodiments and may optionally include a hard exterior layer, formed of a suitable material such as aluminum. Shell 370 may be attached to the main body 320 using an adhesive, or it may be bonded directly onto the main body 320 by molding the shell 370 onto coffee grinder 310, using a standard molding process. Sound insulation appliance 350 also includes base 360, preferably made of a rubber-like material which is attached to either shell 370, coffee grinder 310, or both.

Base 360 and shell 370 combine to form opening 372, which allows power cord 312 to extend through appliance 350. It is to be understood that opening 372 may alternately be formed in base 360 or shell 370 and not necessarily from a combination of the two components. It is also to be understood that base 360 may be removable. It is to be further understood that base 360 may provide structure to actuate or access to any switches that may be located on main body 320 as is described in previous embodiments.

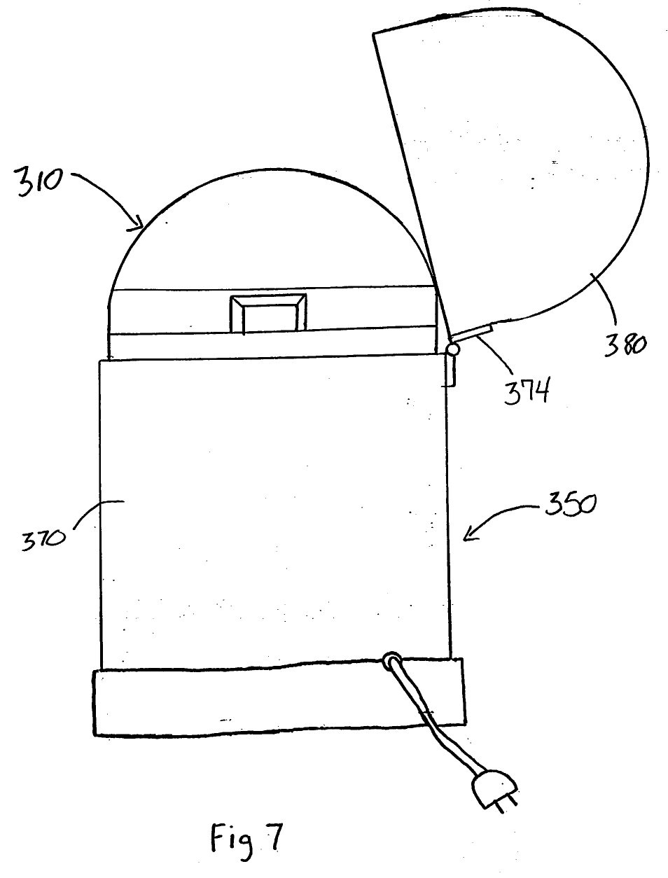

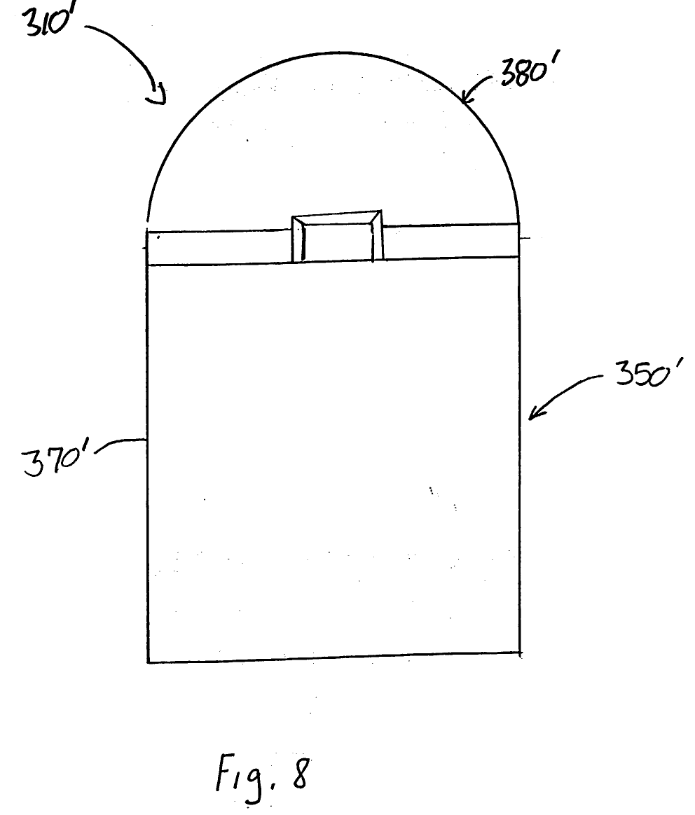

In this embodiment, cover 330 may be free of insulation material. Alternatively, as in FIG. 7, a lid 380 made of similar insulation materials as described in earlier embodiments may be attached to sleeve 370 by a hinge 374. Lid 380 then rotates on hinge 374 over cover 330. Appliance 350′, another alternative, is shown in FIG. 8. Lid 380′ completely surrounds and is attached to the cover (not shown). It should be noted in this alternative that appliance 350′ includes shell 370′, which extends to the bottom of coffee grinder 310′. It is to be understood that coffee grinder 350′ shown in this alternative is of the type with batteries or another self contained power source, although any of the alternatives in the fourth embodiment may include a coffee grinder that either requires a power cord or has a self contained power source. It is to be further understood that the fourth embodiment provides any access to or structure for the actuation of any switches on the grinder, as described in previous embodiments.

In yet another embodiment of the invention (not shown), the concepts described in the above embodiments are adapted to work with a milling or burr-type coffee grinder. Such a grinder may be enclosed by a sound and/or vibration insulated housing with structure to actuate the grinder and allow access to add coffee beans and extract ground coffee. Alternatively, the grinder may include sound and/or vibration insulation integral within or permanently attached to the exterior surface of the grinder.

The present invention provides sound insulation for coffee grinders, clearly providing the advantage of a quiet coffee grinding process over the state of the art. While the current invention has been described with reference to preferred embodiments, workers skilled in the art will recognize that changes may be made in form and detail without departing from the scope of the invention.

What is claimed is:

1. A coffee grinding appliance comprising:
a main body including
a grinding compartment in which coffee beans are ground;
an electric motor; and
a grinding mechanism connected to the electric motor for grinding coffee beans;
an electrical cord extending from the appliance;
an electrical switch connecting the electrical cord to the electrical motor, for actuation by an operator; and
sound and/or vibration insulation material for providing sound insulation when the electric motor is actuated.

2. The appliance of claim 1, wherein at least a portion of the insulation material is contained within the main body.

3. The appliance of claim 2, wherein the insulation material reduces the transfer of sound from the appliance to an external surface that supports the appliance.

4. The appliance of claim 1, and further including a removable member comprised of sound insulation material, for allowing access to ground coffee.

5. The appliance of claim 4, and further including a base comprised of insulation material.

6. The appliance of claim 1, wherein at least a portion of the insulation material is permanently attached to an outside surface of the main body.

7. A sound insulating appliance for a coffee grinder of the type a grinding compartment for receiving coffee beans, a grinding compartment cover which is moveable between open and closed positions for allowing access to the grinding compartment, a coffee grinding mechanism coupled to an electric motor, and a switch for turning the grinder on and off, the appliance comprising:
sound and/or vibration insulation material that substantially surrounds the coffee grinder, for providing sound insulation when the electric motor is actuated;
an access mechanism with an open and closed position for providing access to the grinding compartment cover, so that coffee can be added to the grinding compartment; and
a switch actuation structure for actuating the switch when the access mechanism is in the closed position.

8. The appliance of claim 7, wherein the appliance is configured for use with a coffee grinder of the type also having an electrical cord extending from the grinder and further comprises a first sound insulating member, comprised of insulation material, for receiving the appliance and allowing the electrical cord to extend therefrom.

9. The appliance of claim 8, wherein the appliance further comprises a second sound insulating member comprised of insulation material, which fits over the grinding compartment cover and is movable between an open and closed position to provide the access mechanism to the grinding compartment cover.

10. The appliance of claim 9, wherein the second sound insulating member that, when in the closed position, rests on the first sound insulating member so that the first and second members substantially enclose the grinder.

11. The appliance of claim 9, wherein the second sound insulating member is attached to the first sound insulating member.

12. The appliance of claim 9, wherein the second sound insulating member when in the closed position substantially surrounds the coffee grinder.

13. The appliance of claim 8, wherein the first sound insulating member is comprised of a base and sleeve; wherein the base is located substantially beneath the grinder; wherein the sleeve substantially surrounds the main body of the grinder; and wherein the sleeve and base can be attached to each other at a coupling location.

14. The appliance of claim 13, wherein the base is comprised of deformable rubber-like material.

15. The appliance of claim 13, wherein the sleeve is comprised of a hard outer shell.

16. The appliance of claim 13, wherein the base and sleeve allow the electrical cord to extend through the appliance at the coupling location.

17. The appliance of claim 7, wherein the switch actuation structure is comprised of compressible insulation material.

18. The appliance of claim 7, wherein the insulation material is comprised of closed cell polyurethane foam.

19. A sound insulating appliance for a coffee grinder of the type having a main body comprising a grinding compartment for receiving coffee beans and a coffee grinding mechanism coupled to an electric motor; an electrical cord extending from the grinder; a cover that encloses the compartment; and a switch for turning the grinder on and off, the appliance comprising:
a first sound insulating member comprised of insulation material for receiving the appliance;
a second sound insulating member comprised of insulation material that fits over the cover, is movable between an open and a closed position to permit access to the grinding compartment when in the open position, and cooperates with the first sound insulating member to substantially enclose the grinder when in the closed position; and
a switch actuation structure that allows the operator to actuate the switch.

20. The appliance of claim 19, wherein the first sound insulating member is further comprised of a base and a sleeve; wherein the base is substantially beneath the grinder; wherein the sleeve substantially surrounds the main body of the grinder; and wherein the sleeve and base are attached to each other at a coupling location.

21. The appliance of claim 20, wherein the base is comprised of deformable rubber.

22. The appliance of claim 20, wherein the sleeve is comprised of a hard outer shell.

23. The appliance of claim 20, wherein at least the sleeve is permanently attached to the grinder.

24. The appliance of claim 19, wherein the first sound insulating member allows the electrical cord of the appliance to extend therefrom.

25. The appliance of claim 20, wherein the base and sleeve allow the electrical cord to extend though the appliance at the coupling location.

26. The appliance of claim 19, wherein the second sound insulating member surrounds the removable cover and at least a portion of the main body of the grinder such that moving the second sound insulating member to the open position allows ground coffee to be poured from the grinding compartment without interference from the appliance.

27. The appliance of claim 19, wherein second insulating member includes the switch actuation structure.

28. The appliance of claim 19, wherein the switch actuation structure comprises compressible insulation material.

29. The appliance of claim 19, wherein the second sound insulating member is coupled to the first sound insulating member.

30. The appliance of claim 19, wherein a bottom surface of the coffee grinder is not enclosed by the appliance.

31. The appliance of claim 19, wherein the insulation material is comprised of closed cell polyurethane foam.

32. A sound insulating appliance for a coffee grinder of the type having a main body comprising a grinding compartment for receiving coffee beans and a coffee grinding mechanism coupled to an electric motor; an electrical cord extending from the grinder; a cover that encloses the compartment; and a switch for turning the grinder on and off, the appliance comprising:
a first sound insulating member comprised of insulation material that surrounds and is attached to at least a portion of the main body;
a second sound insulating member comprised of insulation material that fits over the cover, is movable between an open and a closed position to permit access to the grinding compartment when in the open position, and cooperates with the first sound insulating member to substantially enclose the grinder when in the closed position; and
a switch actuation structure that allows the operator to actuate the switch.

33. The appliance of claim 32, wherein the second insulating member is attached to the first sound insulating member.

34. The appliance of claim 32, wherein the second insulating member is permanently attached to the cover.
